(19) United States
(12) Patent Application Publication
(10) Pub. No.: US 2025/0289673 A1
(43) Pub. Date: Sep. 18, 2025

(54) CROSS BELT SORTER CARRIER MEASUREMENT AND MAGNET DETECTION TOOLS

(71) Applicants: Dematic Corp., Grand Rapids, MI (US); Dematic S.r.l, Milan (IT)

(72) Inventors: Andrea Gazzera, Almenno San Salvatore BG (IT); Maximiliano Talano, Monza MB (IT); Peter Maher, Grand Rapids, MI (US)

(21) Appl. No.: 19/081,560

(22) Filed: Mar. 17, 2025

Related U.S. Application Data
(60) Provisional application No. 63/565,905, filed on Mar. 15, 2024.

(51) Int. Cl. B65G 47/53; B65G 43/08

(52) U.S. Cl. CPC B65G 47/53; B65G 43/08; B65G 2203/0283; B65G 2203/043; B65G 2203/044

(57) ABSTRACT

A carrier evaluation system and method configured as a detection tool for use with a cross belt sorter having a plurality of carriers disposed for movement along a travel path and comprises at least one sensor configured for mounting to the cross belt sorter so as to be disposed beneath carriers of the cross belt sorter along the travel path of the carriers and operable for measuring an upward distance from the sensor to a lower portion of the carriers as the carriers pass over the sensor while moving along the travel path. The sensor may be used to measure carrier height and/or distances to an array of magnets for detecting missing magnets. A pair of spaced apart sensors may be used for measuring carrier pitch. The system further provides an alert if the upward measured distance is outside a predetermined limit.

### CROSS REFERENCE TO RELATED APPLICATION

The present application claims the priority benefits of U.S. provisional patent application Ser. No. 63/565,905, filed on Mar. 15, 2024.

### BACKGROUND AND FIELD OF THE INVENTION

The present invention is directed to installation and maintenance tools used for conveyor systems, and in particular an evaluation system and method for carriers of cross belt sorters.

### SUMMARY OF THE INVENTION

The present invention provides a carrier evaluation system and method configured as a detection tool for detecting and measuring parameters of carriers of a cross belt sorter, including carrier pitch, carrier height and detecting magnets associated with the carriers.

According to an aspect of the present invention, a carrier evaluation system for use with a cross belt sorter having a plurality of carriers disposed for movement along a travel path comprises at least one sensor configured for mounting to the cross belt sorter so as to be disposed beneath the carriers of the cross belt sorter along the travel path of the carriers, with the sensor being operable for measuring an upward distance to a lower portion of the carriers as the carriers pass over the sensor while moving along the travel path. The sensor may be configured as a distance sensor, such as a laser sensor, including a high frequency laser sensor.

In a particular arrangement a bracket is used for mounting the sensor to a frame of the cross belt sorter and positioning the sensor beneath the lower portions of the carriers as the carriers move along the travel path. The sensor may be oriented to measure a vertical upward distance.

In one embodiment a pair of sensors are mounted to the cross belt sorter and are separated by a known distance longitudinally relative to the travel path and each are used for measuring an upward distance. In such a configuration, each sensor is configured for measuring an upward distance to the lower portion of individual ones of the carriers for determining a pitch measurement of each of the individual carriers. A carrier detection sensor may be provided that is configured to detect the presence of a carrier moving along the travel path, with the carrier detection sensor output configured for coordinating distance measurements by the pair of sensors. A processing module may be used to receive signals from the pair of sensors and the carrier detection sensor, and/or a computerized data processing system may be used for receiving, processing and evaluating data from the sensors and the carrier detection sensor and outputting information to a user of the carrier evaluation system.

In an embodiment, the upward distance measured by the sensor comprises a carrier height distance, with the sensor being operable to measure the carrier height distance of the plurality of carriers as the carriers pass over the sensor while moving along the travel path. The system and the sensor may be configured and/or operable to measure the carrier height distance of the plurality of carriers during normal production operation of the cross belt sorter.

The output of the sensor may be provided to a controller that is configured to evaluate the carrier height distance of the plurality of carriers and provide an output regarding the carrier height distance of each of the plurality of carriers. The controller may further be configured to provide an alert if a selected one or more of the carrier height distances are outside of a predetermined limit.

In another embodiment the lower portion of each of the plurality of carriers may comprise an array of magnets with the sensor being oriented toward the array of magnets at each carrier and operable to measure an upward distance associated with the array of magnets for detecting a missing magnet. The system, such as by way of a controller, may be operable to provide an alert when the carrier evaluation system detects that a magnet is missing.

According to a further aspect of the present invention, a method of evaluating carriers of a cross belt sorter having a plurality of carriers disposed for movement along a travel path comprises mounting at least one sensor to the cross belt sorter so as to be disposed beneath carriers of the cross belt sorter along a travel path of the carriers, moving the carriers along the travel path of the cross belt sorter such that the carriers pass over the at least one sensor, and measuring with the at least one sensor an upward distance from the sensor to a lower portion of the carriers as the carriers pass over the sensor while moving the carriers along the travel path.

In a particular embodiment the at least one sensor comprises a pair of sensors that are separated by a known distance longitudinally relative to the travel path, and the measuring comprises measuring with both sensors an upward distance from the sensors to the lower portion of individual ones of the carriers for determining a pitch measurement of each of the individual carriers. The method may further include mounting a carrier detection sensor to the cross belt sensor, detecting carriers as they travel along the travel path with the detection sensor, and coordinating distance measurements by the pair of sensors based on the detecting carriers with the detection sensor.

In another particular embodiment, the upward distance measured by the at least one sensor comprises a carrier height distance with the at least one sensor being operable to measure the carrier height distance of the plurality of carriers as the carriers pass over the at least one sensor while moving along the travel path during normal production operation of the cross belt sorter.

In yet another embodiment, the lower portion of each of the plurality of carriers comprises an array of magnets and the at least one sensor is oriented toward the array of magnets at each carrier, and with the measuring comprising measuring with the at least one sensor an upward distance from the at least one sensor to the array of magnets.

In any of the embodiments and configurations, the system may provide an alert if the upward distance from the at least one sensor to the lower portion of the carriers is outside a predetermined limit.

According to an aspect of the present invention, a carrier detection tool for use with a cross belt sorter having a plurality of carriers disposed for movement along a travel path comprises a sensor configured for mounting to a frame of a cross belt sorter so as to be disposed beneath carriers of the cross belt sorter along a travel of the carriers, with the sensor operable for measuring an upward distance from the sensor to a lower portion of the carriers as the carriers pass over said sensor.

The detection tool may include a bracket to which the sensor is mounted with the bracket configured for attachment to the frame of the cross belt sorter. In a particular embodiment the sensor comprise a pair of sensors mounted for measuring an upward distance that is separated along a longitudinal distance relative to the travel path, such as for determining a pitch measurement of each carrier. The carrier detection tool may further comprise a carrier detection sensor configured to detect the presence of a carrier moving along the travel path, with the carrier detection sensor output configured for use in coordinating distance measurements by the pair of sensors.

In a further particular embodiment, the upward distance measured by the sensor comprises a carrier height distance, where the sensor may be configured to measure the carrier height distance of the plurality of carriers during normal production operation of the sorter. The sensor may comprise a high frequency laser sensor. In a particular configuration the output of the sensor is provided to a PLC, which in turn may be operably connected to a controller for the sorter. The sensor may be oriented toward an array of magnets at the carriers with the sensor being operable to measure an upward distance associated with the array of magnets for detecting a missing magnet.

In any of the particular embodiments, the carrier detection tool may include or operate with software configured to provide an alert when a distance measurement or pitch measurement associated with a carrier is detected that is outside of a predetermined limit. Also in any of the embodiments, the one or more sensors may comprise a laser sensor.

The carrier detection tool is thus able to detect pitch, height and/or missing magnets of the carriers to alert operators to the need for maintenance of the sorter prior to the sorter stopping due to a part failure. The carrier detection tool may thus also be referred to as a carrier evaluation tool or system, or carrier measurement tool. These and other objects, advantages, purposes and features of this invention will become apparent upon review of the following specification in conjunction with the drawings.

### BRIEF DESCRIPTION OF THE DRAWINGS

FIG. 1 is a top plan view of a cross belt sorter;

FIG. 2 is a partial perspective view of a section of the cross belt sorter of FIG. 1;

FIG. 3 is a lower perspective view of a section of the cross belt sorter of FIG. 1 illustrating portions of a carrier pitch detection tool in accordance with aspects of the present invention;

FIG. 4 is an opposite side elevation view of the cross belt sorter section and carrier pitch detection tool of FIG. 3;

FIG. 5A is a side elevation view of the portion of the carrier pitch detection tool of FIG. 3 removed from the cross belt sorter;

FIG. 5B is a top plan view of the carrier pitch detection tool of FIG. 5A;

FIG. 5C is a right side elevation view of the carrier pitch detection tool of FIG. 5A;

FIG. 6 is a perspective view of a carrier pitch detection tool in accordance with aspects of the present invention;

FIG. 7 is an upper perspective view of a section of the cross belt sorter of FIG. 1 illustrating the inclusion of portions of a carrier height and magnet detection tool in accordance with aspects of the present invention;

FIG. 8 is a lower perspective view of the cross belt sorter and carrier height and magnet detection tool of FIG. 7;

FIG. 9 is a side elevation view of the cross belt sorter and carrier height and magnet detection tool of FIG. 8;

FIG. 10 is an illustration of a plurality of carriers of a cross belt sorter illustrating a drive system and safety switch;

FIG. 11 is an illustration of an array of magnets used as part of a cross belt sorter with a missing magnet;

FIG. 12 is a computer control cabinet for use with the cross belt sorter of FIG. 1 and the cross belt sorter carrier orientation and magnet detection tools; and

FIG. 13 is a schematic illustration of sensors and controls for use in accordance with aspects of the cross belt sorter carrier orientation and magnet detection tools of the present invention.

### DESCRIPTION OF THE PREFERRED EMBODIMENTS

The present invention will now be described with reference to the accompanying figures, wherein the numbered elements in the following written description correspond to like-numbered elements in the figures.

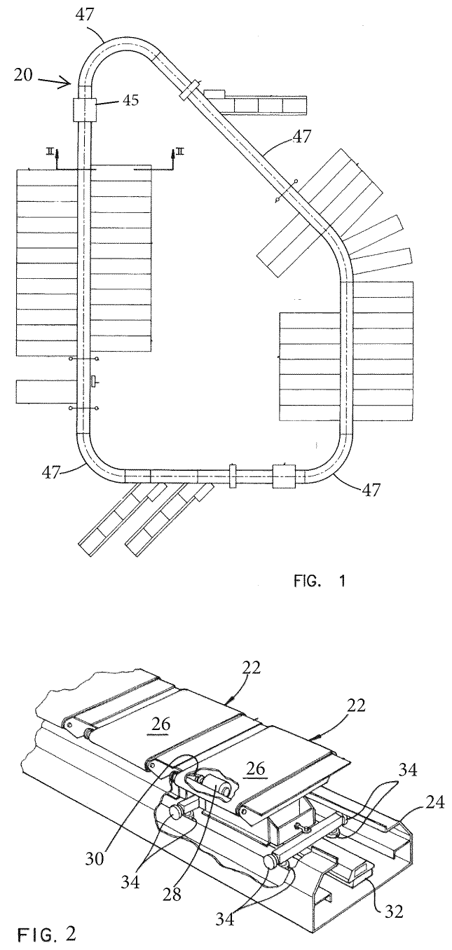

FIG. 1 illustrates an exemplary cross belt sorter or sortation system 20, with FIG. 2 disclosing a portion of the cross belt sorter 20. As understood from FIG. 2, a plurality of transport units or carriers 22 are provided that traverse along a frame 24. Each carrier 22 includes a carrier belt 26 that is driven by an electric motor 28 in a direction orthogonal to the motion of the carrier 22, where carrier belt 26 may be driven in two opposite directions under the control of a servo drive 30. Multiple carriers 22 may be coupled together in order to move in unison in one or more trains along the conveying path of the sorter 20. Carriers 22 are propelled by a linear motor 32 whose stator extends along the guide path of the sorter 20. Each carrier 22 is supported for movement along the conveying path by a set of vertical and horizontal guide wheels 34. The cross belt sorter 20 may be constructed or configured as disclosed in any one of U.S. Pat. Nos. 5,588,520; 6,478,138; 9,233,803, all of which are hereby incorporated herein by reference in their entireties.

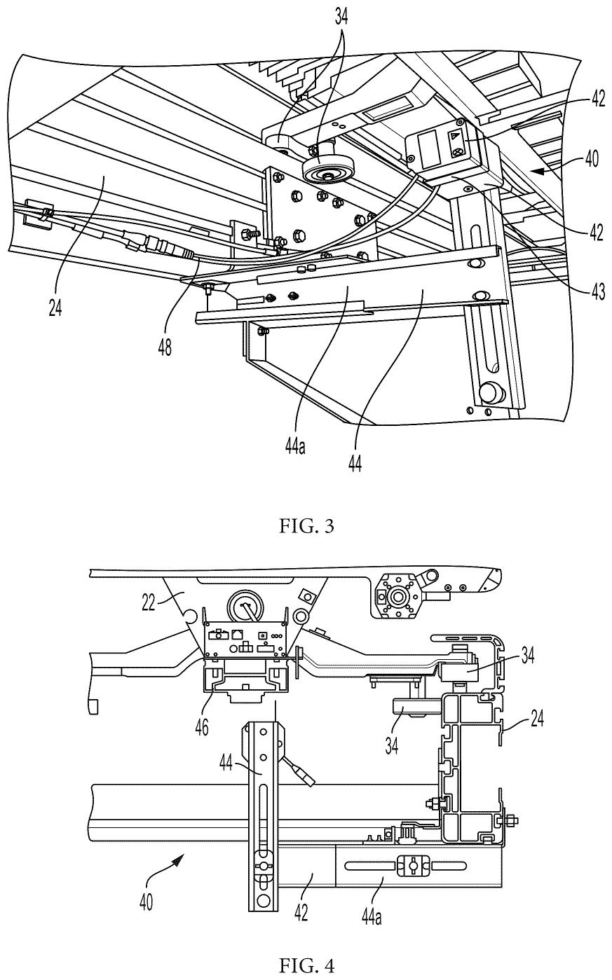

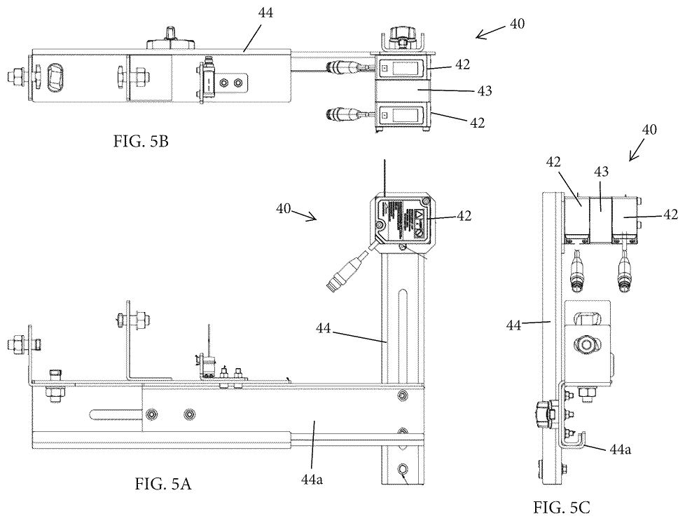

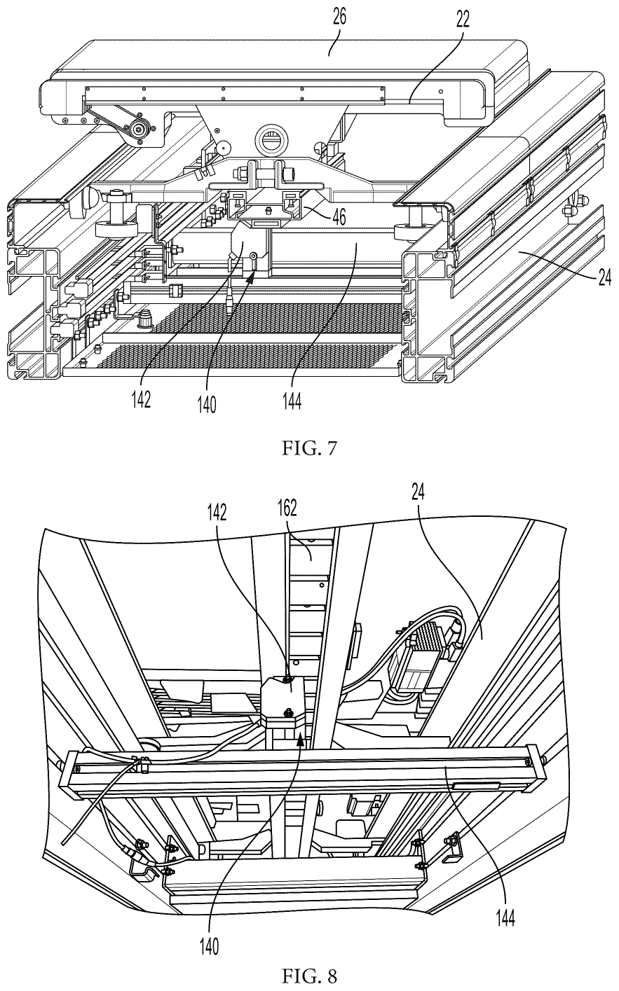

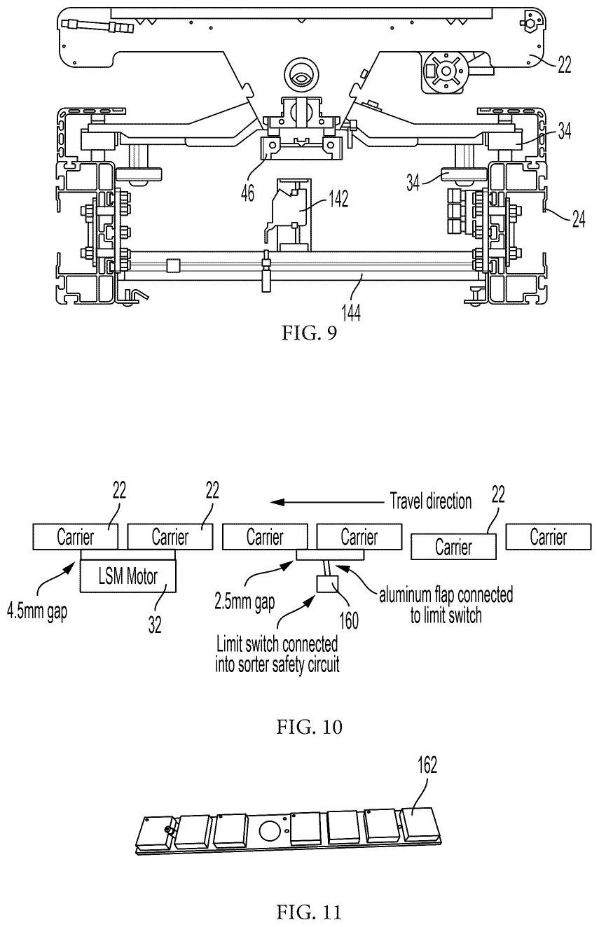

It should be appreciated that the orientation of each of the carriers 22 must be maintained within appropriate specifications for proper operation of the sorter 20. As discussed in detail below with regards to FIGS. 3-6, a carrier detection tool or evaluation system may be configured as a carrier pitch tool 40 is provided for detecting and monitoring the pitch of each carrier 22 during operation of the system 20, as well as a carrier height tool 140 discussed in detail below with regards to FIGS. 7-13 for monitoring the height of each carrier 22 during operation of sorter 20. It should also be understood that in order for the carriers 22 to be properly driven, the system requires an arrangement of magnets. As discussed in detail below, the carrier height tool 140 may further be configured for use in detecting the presence of magnets in an array of such magnets to thereby function as a carrier height and magnet detection tool 140.

With reference to FIGS. 3-6, carrier pitch tool 40 includes a pair of sensors 42 configured as distance sensors that in the illustrated embodiment are laser sensors. Sensors 42 are separated by a known distance in the longitudinal direction of the travel path 47 of the carriers, which in the illustrated embodiment is accomplished by a spacer 43 of known dimension, with the sensors 42 and spacer 43 supported by a bracket 44 mounted to frame 24 so as to be positioned beneath carriers 22 as the carriers 22 traverse along sorter 20. Bracket 44 has a horizontal section 44a that is adjustable in length so as to be able to position the lateral location at which sensors 42 are disposed. Sensors 42 are oriented so as to be directed toward a base or lower or bottom portion 46 of carriers 22. Sensors 42 may be used, for example, to measure the distance between each of the sensors 42 and the respective lower portion 46 of carriers 22. The measurements may be taken while the carriers 22 travel along the sorter 22 and move past the sensors 42. As illustrated, the sensors 42 are disposed so as to be separated from each other by a known amount by spacer 43 with the separation distance extending in the longitudinal direction of the travel path 47 of the carriers 22 on the sorter 20. In the illustrated embodiment, sensors 42 have an analog output of 0-10 volts, with 16 bit, freely scalable within the measuring range. The sensors 42 are able to measure two simultaneous distances, such as on each carrier 22 as well as compare carriers 22 relative to each other. In addition, as noted below, the sensors 42 may be used for measuring the total length of the line or train made up of all the carriers 22 on the sorter 20, as well as used to determine the average speed of the carriers 20 traveling along frame 24 of the system.

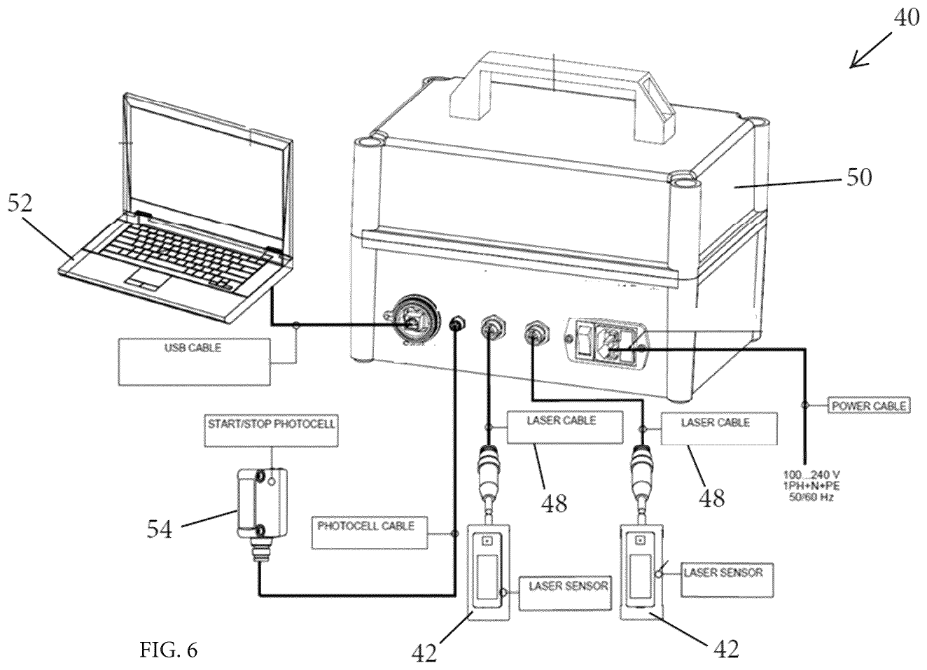

As understood from FIG. 6, each sensor 42 is connected by a cable 48 to a monitoring box or module 50 of the carrier pitch tool 40, where the monitoring box 50 comprises a computer processing module including hardware, such as for processing signals from sensors 42, as well as may comprise software. Monitoring module 50 may, in turn, be connected to a computer device, such as laptop 52 for observing the carrier pitch measurements, including for running software for analyzing signals from sensors 42. Carrier pitch tool 40 further includes a sensor 54 operatively connected to monitoring module 50, where sensor 54 is configured as a detection or trigger or position sensor and in the illustrated embodiment comprises a photocell sensor. Photocell sensor 54 may be mounted to frame 24 and/or bracket 44, such as may be used for detecting the position of a carrier 22 traversing on frame 24 to thereby coordinate the measurements by or taking of measurements by sensors 42 relative to the motion of the carrier 22. That is, the signal from sensor 54 is used to trigger measurements by sensors 42. Although not shown if FIGS. 3-5C, sensor 54 may be mounted to frame 24, bracket 44 or some other location for detection of carriers 22 traversing on sorter 20. The module 50 and laptop 52 together comprise a computerized data processing system for receiving, processing and evaluating the measurement data from sensors 42 and sensor 54, as well as outputting data to a user of the computerized data processing system to provide operational information acquired by system 40. Although shown as separate components, module 50 and 52 may be integrally configured together.

The evaluation system 40 is configured to calculate fundamental parameters of the mechanical conveyor system 20, including: (i) the relative distance (carrier pitch) between every carrier base 46 of the system, (ii) the total length of the line or train made up of all the carriers 22, and (iii) the average speed of the system. The carrier pitch tool 40 thus measures the relative distance (carrier pitch) between every carrier base 46 of the system, the total length of the line made up of all the carriers 22, and the average speed of the system.

In use, the laser sensors 42 are intended for installation on a straight part of the sorter 20 layout, such as close to a maintenance area 45. Preferably, the installation location may be marked or identified for future pitch measurements, such as to avoid measurement variation due to internal movement of the carriers 22. Single carrier pitch acquisition by the tool 40 requires approximately 1.3 seconds on average, according to the specific carrier pitch variants. The timing may be less, such as 0.7 seconds, for smaller carrier pitch values, such as 500 mm, or longer, such as up to 1.9 seconds for the greater carrier pitch, such as 1300 mm.

Laptop 52 includes a program comprising software for use in displaying full graphical information on laptop 52, including displaying the status for each carrier 22 measured, as well as providing alerts or warnings. This includes displaying and identifying the pitch of carriers 22 that are out of tolerance, displaying the carrier pitch of groups of carriers 22, and cumulative pitch deviations. In one embodiment, the following three criteria of acceptance may be displayed: Pass, such as indicating by a green designation, indicating that no modifications to the sorter 20, such as to chains of the sorter 20, are needed; pass with exception, such as indicating by a yellow designation, when some pitch deviations have been found but still within acceptable limits whereby the quality of the sorting process will not be reduced, and; fail, such as indicating by a red designation that pitch corrections are needed, when pitch deviations have been found that could reduce the quality of the sorting process and/or reduce the lifetime of mechanical parts of the sorter 20.

The carrier pitch tool 40 software additionally provides the ability to make virtual pitch adjustments and evaluate the final status before performing mechanical pitch adjustment on the sorter 20.

As a cross belt sorter 20 ages and/or the product mix of items being sorted with the sorter 20 changes, sort accuracy can degrade, causing poor sortation process quality. The advantages of correct pitch of the carriers 22 includes (i) increased lifetime of the track formed by the frame 24, (ii) a reduction of vibrations that may cause noise or failures, (iii) prevention of premature failures of mechanical parts, such as of the track, tape, wheels, carrier brackets, etc. due to fatigue generated by additional vibration, and (iv) maintaining regular throughput (parcel offloading) and structural integrity.

The carrier pitch tool 40, including through its operational software, analyzes key points throughout the system to monitor and display optimal configuration values and variances to support accurate maintenance adjustments. The carrier pitch tool 40 provides the benefits of quick and accurate status monitoring via the control and verification of main geometric parameters of the mechanical conveyors systems. The operational benefits include first time fix and adjustment accuracy requiring less labor and equipment downtime, increased equipment availability during maintenance evaluations and repairs, and maintains high sort accuracy and sorted product conditions.

With reference to FIGS. 7-9, the carrier detection tool or evaluation system may be configured as a carrier height tool 140 that similarly includes a sensor 142 that in the illustrated embodiment is a distance sensor configured as a laser sensor. Sensor 142 is supported by a bracket 144 mounted to frame 24 so as to be positioned beneath carriers 22 as they traverse along sorter 20. Sensor 142 is oriented so as to be directed toward a base or lower or bottom portion 46 of carriers 22. In the illustrated embodiment bracket 144 includes a horizontal section and a vertical section, with the vertical section being positionable along the horizontal section so as to be able to selectively position the sensor 142 at the base 46 of the carriers 22. Sensor 142 may be used, for example, to measure the distance between the sensor 42 and the lower portion 46 of carriers 22. The sensor 142 comprises a high frequency laser sensor, along with vibration resistant and metal sheet reflection, and is directly connected to a local PLC 156 for data collection. In the illustrated embodiment sensor 142 may comprise a high linearity sensor of 0.02% on range 40 μm, with a high repeatability of 0.025 μm, and have a high sample frequency, up to for example 392 KHz. Such sensor 142 may be provided by Keyence Corporation of Itasca, Illinois, U.S.A. Optionally sensors 42 discussed above may be similarly configured as sensor 142. For each carrier 22, the PLC 156 that is synchronized to the sorter controller 158, sends measurement data for elaboration and storage. If the measurement data received are out of limits, the sorter controller 158 generates alerts without stopping the sorter 20. The carrier height tool 140 is thus configured and able to calculate the relative height of each carrier 22 of the sorter 20.

As understood from FIG. 10, carriers 22 are intended to be positioned a particular distance from the linear motor 32, which may be configured as a linear synchronous motor (LSM) motor, of the sorter 20. Sorter 20 may include a limit switch 160 in the event that the height of a given carrier 22 drops whereby damage could be done to linear motor 32. For example, the LSM motor 32 may have an intended installation position to provide a 4.5 mm gap beneath the carriers 22, with the limit switch being configured such that if the height of a carrier above the LSM motor 32 drops below a predetermined value, which is 2.5 mm in the illustrated embodiment of FIG. 10, the limit switch 160 will be triggered, such as to stop operation of sorter 20. Use of carrier height tool 140 may be used to detect such changes in carrier height prior to such a condition. The carrier height tool 140 thus aids in planning repairs and preventative maintenance, as well as aids in auditing the operational condition of the sorter 20, to prevent downtime due to a drop in carrier height. The detection and monitoring of carrier height by the carrier height tool 140 aids in monitoring the wear on running wheels 34 and/or carrier supports or by a manufacturing variation of critical parts, such as pivots of the carriers 22.

In a still further embodiment, the carrier height tool 140 may be configured to detect the total number of magnets of the sorter 20 for detection of missing magnets, whereby the carrier height tool 140 comprises a carrier height and magnet detection tool 140. With reference to FIG. 11, for example, a plurality of magnets 162 comprising a magnet array is illustrated that may form part of the drive system of the sorter 20 for the carriers 22. As noted, the system may be driven by an LSM motor that comprises a stator with electromagnets with the carriers 22 including magnets, such as arrays of magnets. The carrier height and magnet detection tool 140 may be used for detecting missing and/or misaligned magnets from the arrays disposed on the carriers 22. For example, tool 140 may determine the total number of magnets on each carrier 22, such as by sensor 142 detecting a missing or misaligned magnet due to the change in the otherwise uniform arrangement thereof. The monitoring of magnets in this manner aids in maintaining the sorter to have proper motion and efficiency. Of significant note, the carrier height and magnet detection tool 140 is operable to detect carrier height and magnets at production speed. As with tool 40, it is recommended to install the laser sensor 142 close to a maintenance area 45 and on a straight portion of the travel path 47 of the sorter 20.

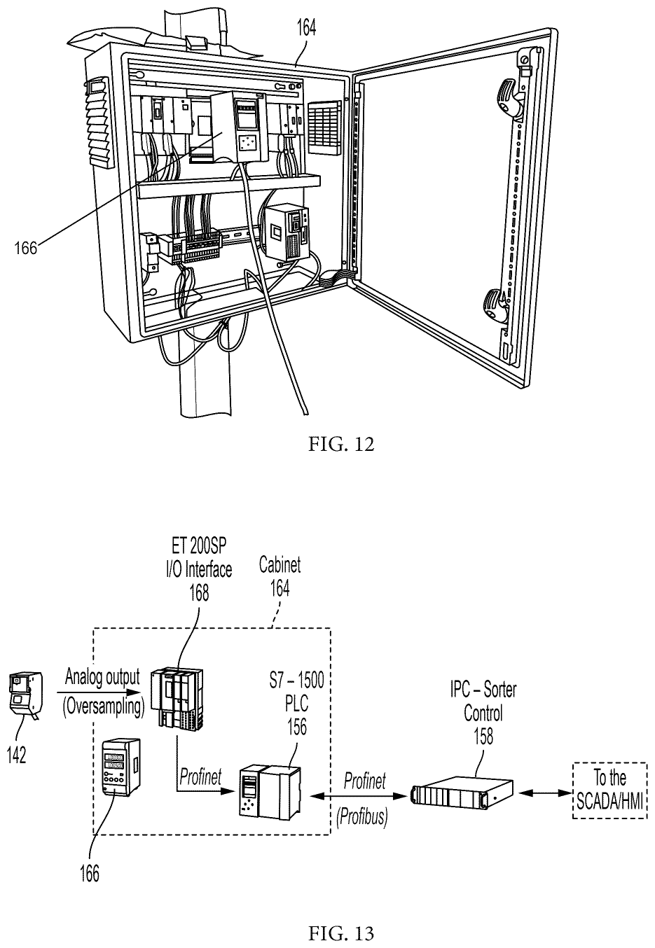

With reference to FIGS. 12 and 13, a control panel or cabinet 164 is shown within which a controller 166, an input/output interface 168 and the PLC 156 are contained. The PLC 156 is configured to analyze the high frequency and precision data from the laser sensor 142 and compute for each carrier 22 (i) the average height value, (ii) standard deviation, (iii) minimum height value, and (iv) maximum height value. The data is further transmitted to the sorter controller 158, which collects and sets alarms if predetermined height limits are exceeded. In particular, the tool 142 provides direct information on a visual display unit about the status of each carrier 22, where for example the visual display unit may be a display screen, such as associated with a computer such as computer 52, or may be a screen integrated with a controller, such as mounted to control panel 164.

In operation, a computerized data processing system such as controller 166 may analyze signals from sensor 142 for determining distances to the lower portion of the carriers 22. This may include evaluating when readings stop and start based on gaps between carriers 22 as well as gaps between trains of interconnected carriers 22. Alternatively and/or additionally, an additional sensor may be employed for use in distinguishing readings from sensor 142, such as a trigger or detection sensor that may be configured, for example, in the manner of sensor 54, such as a photosensor. Still further, the signals may be processed for evaluating the magnets 162 disposed at the base 46 of carriers 22, which may include processing to determine if a discrepancy exists in a distance reading between an expected reading and that obtained when a magnet is missing, which would result in a greater distance being measured. It should be appreciated that the linear array of magnets 162 will create a series of substantially similar readings broken by the gap between magnets 162. The distance to the magnets 162 may be compared to a predetermined range and, if actual readings are outside of that range, such as greater than that range, a warning or an alert can be provided. The warning may be correlated to a specific carrier 22 on the sorter 20. Controller 166 and/or PLC 156 thus comprises a computerized data processing system for receiving, processing and evaluating the measurement data from sensors 142, as well as outputting data to a user of the computerized data processing system to provide operational information acquired by system 140.

In the illustrated embodiment four alerts may be provided: One, to indicate potential problem with one or more wheels 34 of the carrier 22. Two, to indicate a drop in the height of one or more carriers 22 that can trip the limit switch 160 for motor 32 when the height has dropped below a predetermined amount, such as for example by fifty percent (50%) of the gap between the base 46 of the carrier 22 and the motor 32. Three, to indicate a drop in the height of one or more carriers 22 that can trip the motor 32 limit switch 160 when the height has dropped by a predetermined amount, such as for example seventy five percent (75%) of the gap between the base 46 of the carrier 22 and the motor 32. Four, to indicate potential loss of one or more magnets in the base 46 of one or more carriers 22. Accordingly, upon detecting a parameter that is outside of a predetermined value, the evaluation system is able to provide an alert or warning regarding the out of specification condition, including prior to limit switch 160 being activated to stop operation of sorter 20.

As a cross belt sorter such as sorter 20 ages due to wear of components, for example wear of the running wheels 34 or loss of magnets, the sorter 20 may experience intermittent stops causing reduction of performance with downtime instances for troubleshooting. The tool 140 analyzes the height parameter of each carrier 22 and for each loop of the carrier 22 about the travel path 47 of the sorter 20 forwards the measurement data to the sorter control 158. The sorter controller 158 analyzes the data measurement collected and in real-time during operation of sorter 20 is able to generate alerts on HMI/SCADA software if one or more height parameters of carriers 22 exceed predetermined limits, which may be set so as to generate alerts prior to activation of limit switch 160 to thereby prevent emergency stop generation of the sorter 20. As such, sorter 20 may maintain regular performance level. Tool 140 thus beneficially operates to prevent production stopping due to premature failure of critical parts of the carrier 22, such as the wheels 34 and/or wheel pivots, including by identifying if one or more carriers 22 are affected from parts that are anticipated to fail, thus allowing the planning of maintenance of the parts affected in pre-planned scheduled downtime windows.

The tool 140 is configured to measure the relative height of the carrier 22, referred to as the carrier height, between the sensor 142 and every carrier base 46 of the system, as well as measures the minimum and maximum height from every carrier base 46 of the system and detects the magnets. Advantageously, the carrier height and magnet detection tool 140 is able to be used while the sorter 20 is run at the production speed via the high frequency laser sensor 142 to thereby not interfere with production, and is able to provide indication of the potential failure of mechanical parts, including the wheels 34 and wheel pivots or axels, and is able to detect a loss of magnets.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A carrier evaluation system for use with a cross belt sorter having a plurality of carriers disposed for movement along a travel path, said carrier evaluation system comprising:
a sensor configured for mounting to a cross belt sorter so as to be disposed beneath carriers of the cross belt sorter along a travel path of the carriers;
said sensor operable for measuring an upward distance from the sensor to a lower portion of the carriers as the carriers pass over said sensor while moving along the travel path.

2. The carrier evaluation system of claim 1, wherein said sensor comprises a distance sensor.

3. The carrier evaluation system of claim 2, wherein said distance sensor comprises a laser sensor.

4. The carrier evaluation system of claim 1, further comprising a bracket to which said sensor is mounted with said bracket configured to being attached to a frame of the cross belt sorter for positioning said sensor beneath the lower portions of the carriers as the carriers move along the travel path.

5. The carrier evaluation system of claim 1, wherein said sensor comprises a pair of sensors, wherein said pair of sensors are each mounted for measuring an upward distance and are separated by a known distance longitudinally relative to the travel path.

6. The carrier evaluation system of claim 5, wherein each said sensor is configured for measuring an upward distance to the lower portion of individual ones of the carriers for determining a pitch measurement of each of the individual carriers.

7. The carrier evaluation system of claim 6, further comprising a carrier detection sensor, wherein said carrier detection sensor is configured to detect the presence of a carrier moving along the travel path, and wherein said carrier detection sensor output is configured for coordinating distance measurements by said pair of sensors.

8. The carrier evaluation system of claim 7, further comprising a processing module for receiving signals from said sensors and said carrier detection sensor.

9. The carrier evaluation system of claim 7, further comprising a computerized data processing system for receiving, processing and evaluating data from said sensors and said carrier detection sensor and outputting information to a user of said carrier evaluation system.

10. The carrier evaluation system of claim 1, wherein the upward distance measured by said sensor comprises a carrier height distance, and wherein said sensor is operable to measure the carrier height distance of the plurality of carriers as the carriers pass over said sensor while moving along the travel path.

11. The carrier evaluation system of claim 10, wherein said sensor is operable to measure the carrier height distance of the plurality of carriers during normal production operation of the cross belt sorter.

12. The carrier evaluation system of claim 10, wherein the output of said sensor is provided to a controller, and wherein said controller is configured to evaluate the carrier height distance of the plurality of carriers and provide an output regarding the carrier height distance of each of the plurality of carriers.

13. The carrier evaluation system of claim 12, wherein said controller is configured to provide an alert if a selected one or more of the carrier height distances are outside of a predetermined limit.

14. The carrier evaluation system of claim 1, wherein the lower portion of each of the plurality of carriers comprises an array of magnets, and wherein said sensor is oriented toward the array of magnets at each carrier, and wherein said sensor is operable to measure an upward distance associated with the array of magnets for detecting a missing magnet.

15. The carrier evaluation system of claim 14, further comprising a controller operable to provide an alert when said carrier evaluation system detects that a magnet is missing.

16. A method of evaluating carriers of a cross belt sorter having a plurality of carriers disposed for movement along a travel path, said method comprising:
mounting at least one sensor to a cross belt sorter so as to be disposed beneath carriers of the cross belt sorter along a travel path of the carriers;
moving the carriers along the travel path of the cross belt sorter such that the carriers pass over the at least one sensor; and
measuring with the at least one sensor an upward distance from the sensor to a lower portion of the carriers as the carriers pass over the sensor while moving the carriers along the travel path.

17. The method of claim 16, wherein the at least one sensor comprises a pair of sensors, and wherein the pair of sensors are separated by a known distance longitudinally relative to the travel path, and wherein said measuring comprises measuring with both sensors an upward distance from the sensors to the lower portion of individual ones of the carriers for determining a pitch measurement of each of the individual carriers.

18. The method of claim 17, further comprising:
mounting a carrier detection sensor to the cross belt sensor;
detecting carriers as they travel along the travel path with the detection sensor; and
coordinating distance measurements by the pair of sensors based on said detecting carriers with the detection sensor.

19. The method of claim 16, wherein the upward distance measured by the at least one sensor comprises a carrier height distance, and wherein the at least one sensor is operable to measure the carrier height distance of the plurality of carriers as the carriers pass over the at least one sensor while moving along the travel path during normal production operation of the cross belt sorter.

20. The method of claim 16, wherein the lower portion of each of the plurality of carriers comprises an array of magnets and the at least one sensor is oriented toward the array of magnets at each carrier, and wherein said measuring comprises measuring with the at least one sensor an upward distance from the at least one sensor to the array of magnets.

21. The method of claim 16, further comprising providing an alert if the upward distance from the at least one sensor to the lower portion of the carriers is outside a predetermined limit.
